(19) United States
(12) Patent Application Publication
(10) Pub. No.: US 2008/0292176 A1
(43) Pub. Date: Nov. 27, 2008

(54) Pattern inspection method and pattern inspection apparatus

(76) Inventors: Kaoru Sakai, Yokohama (JP); Shunji Maeda, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/153,329

(22) Filed: May 16, 2008

(30) Foreign Application Priority Data
May 16, 2007 (JP) 2007-130433

(51) Int. Cl. G06K 9/64

(52) U.S. Cl. 382/144

(57) ABSTRACT

In a pattern inspection apparatus for comparing images of areas corresponding to patterns each formed so as to be the same pattern and determining a non-coincident portion of the image as a defect, an image comparison processing unit configured with a processing system mounting a plurality of CPUs operating in parallel is provided, whereby an effect of brightness irregularity between the comparison images generated from a difference of a film thickness, a difference of a pattern thickness, and the like can be reduced, and a highly sensitive pattern inspection can be performed without setting parameters. Further, a feature amount of each pixel is calculated between the comparison images, and a plurality of feature amounts are compared, so that distinction between a defect and a noise, which is impossible by a luminance value, can be performed with high accuracy.

### CROSS-REFERENCE TO RELATED APPLICATION

The present application claims priority from Japanese Patent Application No. JP 2007-130433 filed on May 16, 2007, the content of which is hereby incorporated by reference into this application.

### BACKGROUND OF THE INVENTION

The present invention relates to an inspection in which an image of an target obtained by using light, laser, electron beam or the like is compared with a reference image to detect a micro pattern defect, a foreign matter and the like based on the comparison result. More particularly, it relates to a pattern inspection method and a pattern inspection apparatus suitable for performing an appearance inspection of a semiconductor wafer, TFT, a photo mask, and the like.

As a conventional technology for performing defect detection by comparing an inspection target image and a reference image, a method is known as disclosed in Japanese Patent Application Laid-Open Publication No. 5-264467 (Patent Document 1).

This method is a method in which inspection target samples whose repetitive patterns are regularly arranged are taken as an image in turn by a line sensor and it is compared with an image having a time lag by a repetitive pattern pitch to detect its unconformity portion as a defect. Such a conventional inspection method will be described with an example of a defect inspection for a semiconductor wafer. In the semiconductor wafer to be an inspection target, as shown in FIG. 2A, a number of chips having the same pattern are regularly arranged. In a memory device such as a DRAM, as shown in FIG. 2B, each chip can be broadly classified into a memory matt unit 20-1 and a peripheral circuit unit 20-2. The memory matt unit 20-1 is an aggregation of a small repetitive pattern (cell), and the peripheral circuit unit 20-2 is basically an aggregation of a random pattern. In general, the memory matt unit 20-1 has a high pattern density, and an image obtained by a bright-field illumination optical system becomes dark. In contrast to this, the peripheral circuit unit 20-2 has a low pattern density, and the obtained image is bright.

In the conventional pattern inspection, luminance values of images of chips of the peripheral circuit unit 20-2 adjacent to each other at the same positions in, for example, areas 22 and 23 of FIG. 2 are compared, and a portion in which a difference between the values is larger than a threshold value is detected as a defect. Hereinafter, such inspection is described as a chip comparison. Luminance values of images of adjacent cells of the memory matt unit 20-1 inside the memory matt unit are compared, and similarly a portion in which a difference between the values is larger than a threshold value is detected as a defect. Hereinafter, such inspection is described as a cell comparison. These comparison inspections are required to be performed at high speed.

### SUMMARY OF THE INVENTION

Now, in the semiconductor wafer to become an inspection target, since a fine difference in thickness in the pattern occurs even between adjacent chips, the images between the chips have locally a difference in brightness. As in the conventional method, when a portion where a luminance difference becomes a specific threshold value TH or more is taken as a defect, an area different in brightness due to such difference of the film thickness is also detected as a defect. This area does not have to be essentially detected as a defect. In other words, it is false information, and in the conventional inspection, as a method of avoiding generation of the false information, the threshold value for detecting the defect has been set high. However, this leads to deterioration of sensitivity, and a defect having a difference value almost equal to or less than the threshold value cannot be detected. Further, a difference in brightness due to the film thickness occurs only between specific chips inside the wafer, or occurs only in a specific pattern inside the chip from among the array chips shown in FIG. 2. When the threshold value is adjusted to these local areas, the overall inspection sensitivity is remarkably reduced.

Further, as a cause of impairing the sensitivity, there is a difference in brightness between the chips due to variation of the thickness of the pattern. In the conventional comparison inspection with brightness, when there is such variation of brightness, it becomes a noise at the time of inspection.

On the other hand, there are various kinds of defects. These defects can be mainly classified into defects not to be detected (taken as noises) and defects to be detected. For an appearance inspection, although extraction of only the defect desired by a user is required from among a vast number of defects, this is difficult to realize by comparison of the luminance difference and the threshold value. In contrast to this, by combination of factors depending on an inspection target such as a material, a surface roughness, a size, and a depth, and factors depending on a detection system such as an illumination condition, visibility often changes according to kinds of defects.

Hence, the present invention can solve such problems of the convention inspection technology. In a pattern inspection in which images of areas corresponding to patterns each formed to have the same pattern are compared to each other to determine the unconformity portion of the image as a defect, an object of the present invention is to realize a pattern inspection technology for reducing brightness irregularity between the comparison images caused due to the differences of film thickness and pattern thickness; and detecting a defect desired by the user, which is buried in noises and defects not required to be detected, with high sensitivity and high speed.

The novel feature of the present invention will become apparent from the description of the specification and the accompanying drawings.

The typical ones of the inventions disclosed in this application will be briefly described as follows.

In the present invention, in a pattern inspection (pattern inspection method and pattern inspection apparatus) in which images of the areas corresponding to patterns each formed to have the same pattern are compared to each other to determine the unconformity portion of the image as a defect, by using a processing system mounting a plurality of CPUs operating in parallel, influence of brightness irregularity between the comparison images due to the differences of film thickness and pattern thickness is reduced, whereby a highly sensitive pattern inspection can be performed without setting a parameter.

Further, in the present invention, in the pattern inspection technology, a feature amount of each pixel is calculated between the comparison images, and the plurality of feature amounts are compared, whereby a distinction, which is impossible to be distinguished by the luminance value, between the defect and the noise can be realized with high accuracy.

Further, the comparison is made by the plurality of feature amounts, and a plurality of defect determination threshold values required for detecting the defect are automatically calculated, so that the setting of the threshold value by the user is completely eliminated. This is performed by specifying an example of a defect image or a non-defect image by the user.

Further, in the present invention, the feature amounts of the images outputted from a plurality of illumination conditions and a plurality of detection systems are integrated on a feature space to perform a defect determination, so that kinds of defects to be detected can be expanded and various kinds of defects can be detected with high sensitivity.

Further, by comparing similar patterns inside the same image and detecting a defect, the inspection of the chip having a large fluctuation of the brightness and the detection of the systematic defect are made possible.

Furthermore, by performing a different defect determination processing according to pattern shapes inside the image, the detection of the defect can be realized with high sensitivity.

Further, a system configuration of the processing unit for the defect detection is configured with a plurality of CPUs operating in parallel, so that a pattern inspection in which each processing is freely allotted to the CPUs can be performed with high speed and high sensitivity.

Further, the invention is a pattern inspection method for taking a plurality of images of areas corresponding to patterns each formed to become the same pattern on a sample to detect a defect, wherein an image of an inspection target pattern and an image of a corresponding reference pattern are obtained by imaging the pattern on the sample to be the inspection target, and then a processing for detecting the defect from the obtained inspection target image and a processing for detecting the defect from the obtained inspection target image and the reference image are performed, whereby the defect is detected.

Further, the invention is an apparatus for inspecting the defect of the pattern formed on the sample, and the apparatus includes illumination means for illuminating an optical image of the pattern under a plurality of illumination conditions; detection means for detecting the optical image of the pattern under the plurality of detection conditions; means for inputting a defect portion or a non-defect portion specified by the user; and defect extraction means for calculating a threshold value for defect determination according to the input of the user and for extracting a defect candidate.

Further, the invention is an apparatus for inspecting the defect of the pattern formed on the sample, and the apparatus includes: illumination means for illuminating an optical image of the pattern under a plurality of illumination conditions; detection means for detecting the optical image of the pattern under the plurality of detection conditions; means for comparing the inspection target image and the corresponding reference image and detecting the defect; and means for detecting the defect from only the inspection target image.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a view showing an example of a configuration of a defect inspection apparatus according to one embodiment of the present invention;

FIG. 2A is a view showing an example of a configuration of chips according to one embodiment of the present invention;

FIG. 2B is a view showing an example of a configuration of chips according to one embodiment of the present invention;

FIG. 3 is a view showing an example of a defect candidate extraction processing flow according to one embodiment of the present invention;

FIG. 4A is a view showing an example of a CPU configuration of an image processing system according to one embodiment of the present invention;

FIG. 4B is a view showing an example of a CPU configuration of an image processing system according to one embodiment of the present invention;

FIG. 5A is a view showing an example of processing in the CPU configuration of FIG. 4 according to one embodiment of the present invention;

FIG. 5B is a view showing an example of processing in the CPU configuration of FIG. 4 according to one embodiment of the present invention;

FIG. 5C is a view showing an example of processing in the CPU configuration of FIG. 4 according to one embodiment of the present invention;

FIG. 6 is a view showing an example of processing in the CPU configuration of FIG. 4 according to one embodiment of the present invention;

FIG. 7A is a view showing an example of processing in the CPU configuration of FIG. 4 according to one embodiment of the present invention;

FIG. 7B is a view showing an example of processing in the CPU configuration of FIG. 4 according to one embodiment of the present invention.

FIG. 8A is a view showing an example of equalization processing of an calculation load according to one embodiment of the present invention;

FIG. 8B is a view showing an example of equalization processing of an calculation load according to one embodiment of the present invention;

FIG. 8C is a view showing an example of equalization processing of an calculation load according to one embodiment of the present invention;

FIG. 9A is a view showing an example of a brightness comparison trouble between chips according to one embodiment of the present invention;

FIG. 9B is a view showing an example of a brightness comparison trouble between chips according to one embodiment of the present invention;

FIG. 9C is a view showing an example of a brightness comparison trouble between chips according to one embodiment of the present invention;

FIG. 9D is a view showing an example of a brightness comparison trouble between chips according to one embodiment of the present invention;

FIG. 10 is a view showing an example of defect detection processing by a single chip according to one embodiment of the present invention;

FIG. 11A is a view showing an example of a similar pattern inside a single chip image according to one embodiment of the present invention;

FIG. 11B is a view showing an example of a similar pattern inside a single chip image according to one embodiment of the present invention;

FIG. 12 is a view showing an embodiment of processing of a single chip image and comparison processing between chips in the CPU configuration of FIG. 4 according to one embodiment of the present invention;

FIG. 13 is a view showing an example of a defect inspection apparatus configured with a plurality of detection optical systems according to one embodiment of the present invention;

FIG. 14A is a view showing an example of an integrating method of information obtained from the plurality of detection optical systems according to one embodiment of the present invention;

FIG. 14B is a view showing an example of an integrating method of information obtained from the plurality of detection optical systems according to one embodiment of the present invention;

FIG. 15A is a view showing an example of an integrating method of information obtained from the plurality of detection optical systems according to one embodiment of the present invention;

FIG. 15B is a view showing an example of an integrating method of information obtained from the plurality of detection optical systems according to one embodiment of the present invention;

FIG. 16A is a view showing an example of integrating processing of information obtained by a plurality of optical conditions according to one embodiment of the present invention;

FIG. 16B is a view showing an example of integrating processing of information obtained by a plurality of optical conditions according to one embodiment of the present invention;

FIG. 16C is a view showing an example of integrating processing of information obtained by a plurality of optical conditions according to one embodiment of the present invention;

FIG. 16D is a view showing an example of integrating processing of information obtained by a plurality of optical conditions according to one embodiment of the present invention;

FIG. 16E is a view showing an example of integrating processing of information obtained by a plurality of optical conditions according to one embodiment of the present invention;

FIG. 17A is a view showing an example in which defects and noises can be discriminated in a multidimensional feature space according to one embodiment of the present invention;

FIG. 17B is a view showing an example in which defects and noises can be discriminated in a multidimensional feature space according to one embodiment of the present invention;

FIG. 18A is a view showing an example of a sensitivity adjustment procedure by a user according to one embodiment of the present invention;

FIG. 18B is a view showing an example of a sensitivity adjustment procedure by a user according to one embodiment of the present invention;

FIG. 19A is a view showing an example of an image in which a plurality of pattern shapes coexist according to one embodiment of the present invention; and

FIG. 19B is a view showing an example of an image in which a plurality of pattern shapes coexist according to one embodiment of the present invention.

### DESCRIPTION OF THE PREFERRED EMBODIMENTS

Embodiments of the present invention will be described below in detail with reference to the drawings. In the entire drawings for explaining the embodiments, as a general rule, the same members will be denoted by the same reference numbers, and the repetitive description thereof will be omitted.

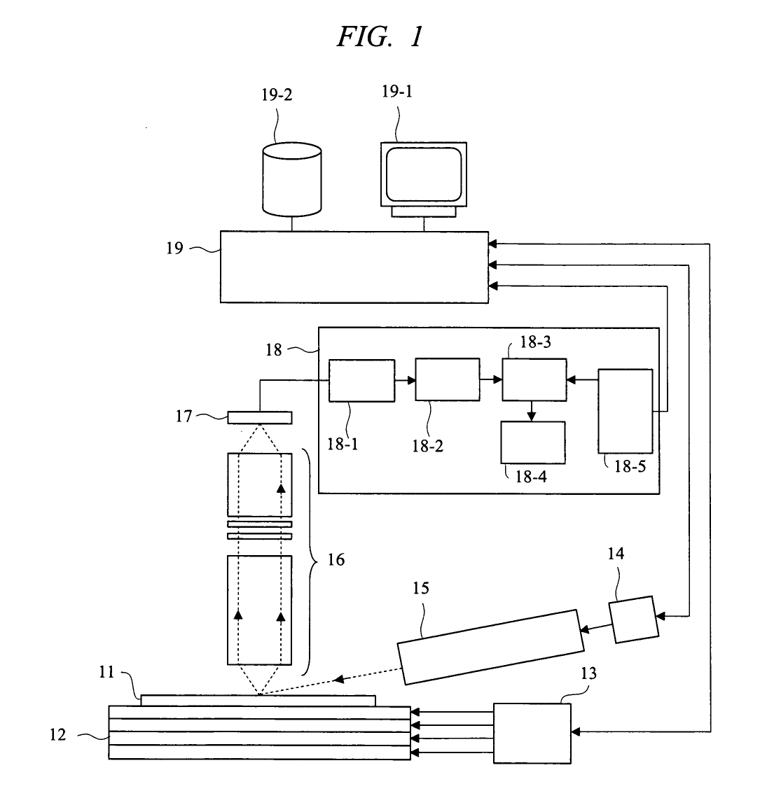

In the following, one embodiment of a pattern inspection technology (pattern inspection method and pattern inspection apparatus) according to the present invention will be described in detailed with reference to FIGS. 1 to 19.

One embodiment of the pattern inspection technology according to the present invention will be described with an example of a defect inspection method in a defect inspection apparatus with dark field illumination for a semiconductor wafer.

FIG. 1 shows an example of a configuration of the defect inspection apparatus with the dark field illumination according to the present embodiment. The defect inspection apparatus according to the present embodiment is configured with a sample 11, a stage 12, a mechanical controller 13, a light source 14, an illumination optical system 15, an upper detection system 16, an image sensor 17, an image comparison processing unit 18 (a pre-processing unit 18-1, an image memory 18-2, a defect inspection unit 18-3, a defect classification unit 18-4, and a parameter setting unit 18-5), an overall control unit 19 (a user interface unit 19-1 and a memory device 19-2), and the like.

The sample 11 is a target to be inspected such as a semiconductor wafer. The stage 12 mounts the sample 11 and can move and rotate (θ) inside an XY plane and move in a Z direction. The mechanical controller 13 is a controller to move the stage 12. In the light source 14 and the illumination optical system 15, light emitted from the light source 14 is irradiated to the sample 11 by the illumination optical system 15; scattered light from the sample 11 is formed into an image by the upper detection system 16; and an formed optical image is received by the image sensor 17 to convert it into an image signal. At this time, the sample 11 is mounted on the stage 12 driven in the directions X-Y-Z-θ, and while the stage 12 is moved in a horizontal direction, the scattered light from a foreign matter is detected, thereby obtaining a detection result as a two-dimensional image.

Here, as the light source 14, a laser has been used in the example shown in FIG. 1. However, a lamp may be used. Further as a wavelength of the light emitted from the light source 14, it may be a short wavelength, and may be light (white light) of wideband wavelength. When light of a short wavelength is used, in order to increase resolution of an image to be detected (to detect a fine defect), light (Ultra Violet Light: UV light) of the wavelength in the ultraviolet range can be also used. When a laser is used as a light source, in the case of using the laser of short wavelength, means for reducing coherence (not shown) can be also provided inside the illumination optical system 15 or between the light source 14 and the illumination optical system 15.

Further, a time delay integration image sensor (TDI image sensor) configured with a plurality of one dimensional image sensors arranged in two-dimension is adopted to the image sensor 17. A signal detected by each one dimensional sensor synchronizing with the movement of the stage 12 is transferred and added to the one dimensional image sensor of the next stage, so that a two dimensional image can be obtained relatively at high speed with high sensitivity. As this TDI image sensor, a sensor of a parallel output type comprising a plurality of output taps are used, so that outputs from the sensors can be processed in parallel, thereby making it possible to detect at a faster speed. Further, when a sensor of the rear surface illumination type is used for the image sensor 17, detection efficiency can be increased as compared with the case of using a sensor of the front surface illumination type.

The image comparison processing unit 18 extracting the defect candidate on the wafer being the sample 11 includes: the pre-processing unit 18-1 that performs an image correction such as shading correction and dark level correction to the detected image signal; the image memory 18-2 that stores a digital signal of the corrected image; the defect detection unit 18-3 that compares the images of the corresponding areas stored in the image memory 18-2 and extracts the defect candidate; the defect classification unit 18-4 that classifies the detected defect into a plurality of kinds of defects; and the parameter setting unit 18-5 that sets parameters of the image processing. This image comparison processing unit 18, though the detail thereof will be described later, is configured with a processing system mounting a plurality of CPUs operating in parallel.

First, the digital signals of an image (hereinafter, described as a detection image) of an inspection area which is corrected and stored in the image memory 18-2 and an image (hereinafter, described as a reference image) of an corresponding area are read; correction amount for correction of the position in the defect detection unit 18-3 is calculated; position adjustment of the detection image and the reference image is performed by using the calculated position correction amount; and a pixel having a shifted value on a feature space is outputted as a defect candidate by using the feature amount of the corresponding pixel. The parameter setting unit 18-5 sets image processing parameters, inputted from the outside, such as a kind of the feature amount and a threshold value when extracting the defect candidate, and gives the parameters to the defect detection unit 18-3. In the defect classification unit 18-4, a real defect is extracted from the feature amount of each defect candidate, and is classified.

The overall control unit 19 comprises an CPU performing a variety of controls (incorporated into the overall control unit 19), and is connected to an user interface unit 19-1 having display means and input means which receive the change of inspection parameters (a kind of the feature amount, a threshold value and the like which are used for extraction of the shifted value) from the user and which display the detected defect information, and is connected to the memory device 19-2 storing the feature amount and the image of the detected defect candidate. The mechanical controller 13 drives the stage 12 based on a control command from the overall control unit 19. The image comparison processing unit 18 and the optical system and the like are also driven according to the command from the overall control unit 19.

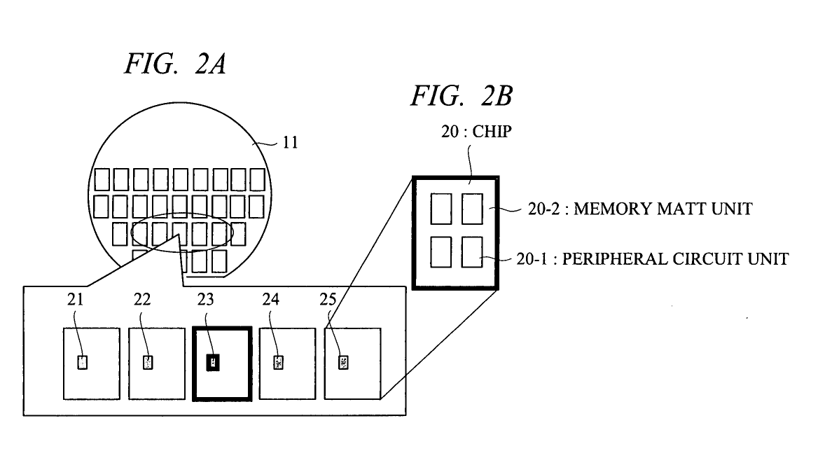

In the sample (also described as a semiconductor wafer or wafer) 11 being an inspection target, as shown in FIG. 2, a number of chips 20 having the same pattern configured with a memory matt unit 20-1 and a peripheral circuit unit 20-2 are regularly aligned. In the overall control unit 19, the semiconductor wafer 11 being the sample is continuously moved by the stage 12, and the image of the chip is sequentially received from the image sensor 17 in synchronization with this movement. Digital image signals of areas 21, 22, 24, and 25 are set to be reference images with respect to the detection image, for example, with respect to the same position of the chips regularly aligned, that is, the area 23 of the detection image of FIG. 2. Then the corresponding pixels of the detection image and other pixels inside the detection image are compared to the reference images to detect pixels having a large difference as the defect candidates.

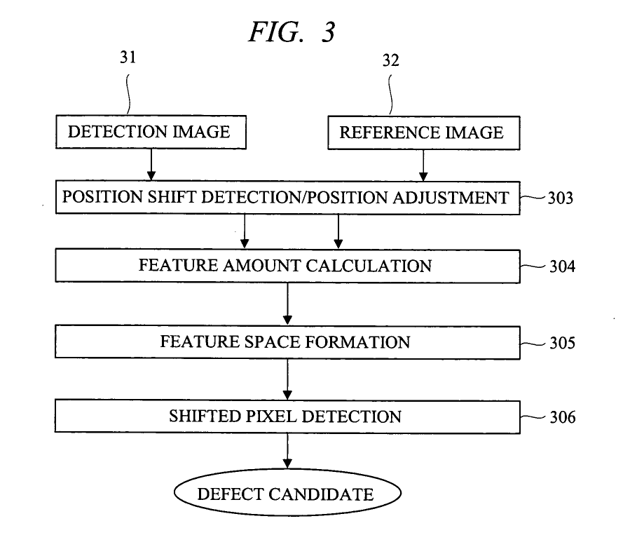

FIG. 3 shows an example of a processing flow of the defect detection unit 18-3 for the image (area 23) of the chip being the inspection target shown in FIG. 2. First, an image (detection image 31) of the chip being the inspection target and a corresponding reference image 32 (here, the image of the adjacent chip which is 22 of FIG. 2) are read from the image memory 18-2, and a position shift is detected to perform position adjustment (303).

Next, for each pixel of the detection image 31 subjected to the position adjustment, a plurality of feature amounts are calculated with the corresponding pixel of the reference image 32 (304). The feature amount may represent the features of the pixel. One example of the feature amount includes such as (1) Brightness, (2) Contrast, (3) Contrast Difference, (4) Brightness Dispersion Value of the Adjacent Pixel, (5) Coefficient of Correlation, (6) Increase and Decrease of Brightness with the Adjacent Pixel, and (7) Second Derivative Value.

One example of these feature amounts can be represented by the following formulas, assuming that the brightness of each point of the detection image is taken as f(x, y), and the brightness of the corresponding reference image is taken as g (x, y).

### (1) Brightness;

f(x,y) or {f(x,y)+g(f,y)}/2 (Formula 1)

### (2) Contrast;

max{f(x,y), f(x+1,y), f(x,y+1), f(x+1,y+1)}−min{f(x,y), f(x+1,y), f(x,y+1), f(x+1,y+1)} (Formula 2)

### (3) Contrast Difference;

f(x,y)−g(x,y) (Formula 3)

### (4) Dispersion Value;

[Σ{f(x+i,y+j)²}−{Σf(x+i,y+j)}²/M]/(M−1)

i,j=−1,0,1M=9 (Formula 4)

By plotting each pixel in a space where some of these feature amounts or all the feature amounts are taken as an axis, a feature space is formed (305). The pixel plotted outside data distribution in this feature space, that is, the pixel having a characteristic shifted value is detected as a defect candidate (306).

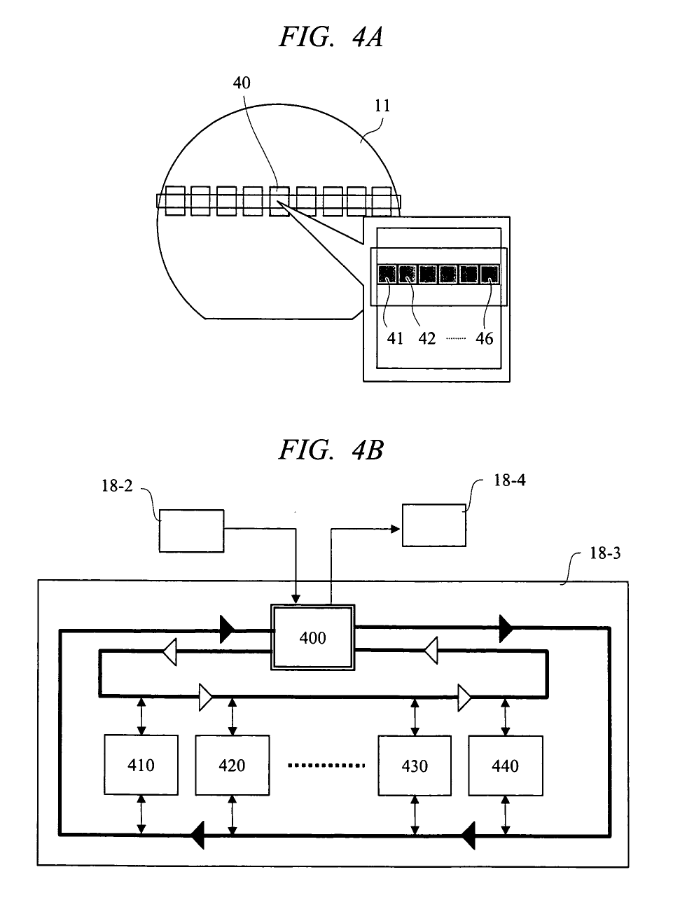

Here, since an image of the chip being the inspection target can be continuously obtained with the movement of the stage 12 of FIG. 1, the image is cut out to a specific length and is subjected to the defect inspection processing. FIG. 4A is an example where a chip 40 inside the semiconductor wafer 11 being the inspection target is taken as an inspection target and the image is inputted by the sensor. The inputted image of the chip 40 is shown as cut out into six (six images) of 41 to 46. FIG. 4B shows an example of a system configuration of the image comparison processing unit 18 for such an image, which performs the defect inspection processing shown in FIG. 3.

First, the image processing system to perform the defect detection is configured with a plurality of calculation CPUs as shown by 400, 410, 420, 430, and 440. The calculation CPU 400 from among these calculation CPUs is a CPU which performs the same calculation as other calculation CPUs, and also performs transfer of the image data to other calculation CPUs; command of the calculation execution; data delivery and receipt to and from the outside; and the like. Hereinafter, this calculation CPU 400 is described as a master CPU. Further, plural pieces of the calculation CPUs 410 to 440 (hereinafter, described as slave CPUs) other than this master CPU receive a command from the master CPU to perform the execution of the calculation and the delivery and receipt of the data from and to the other slave CPUs and the like. The salve CPU can mutually execute the same processing with the other slave CPUs in parallel. Further, the slave CPU can also mutually execute a separate processing with the other slave CPUs in parallel. The delivery and receipt between the slave CPU and the master CPU is performed through a data communication bus.

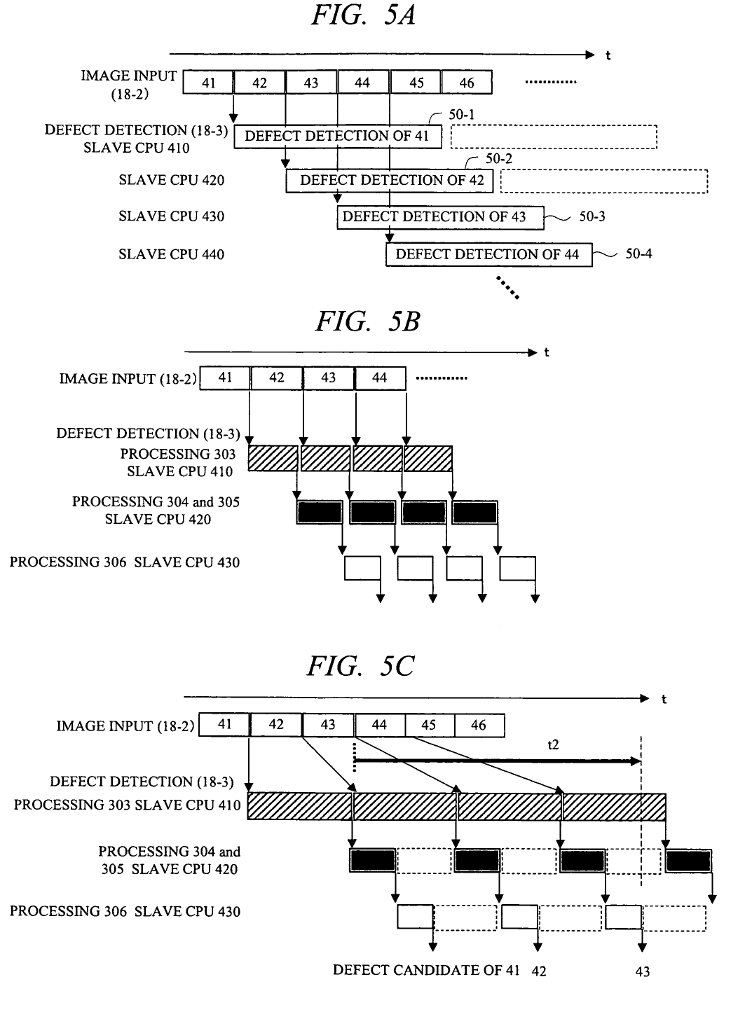

An example of a processing flow for the six images 41 to 46 shown in FIG. 4A will be shown in FIG. 5. FIG. 5A shows a flow of a general parallel processing after the images 41 to 46 being the inspection targets and the corresponding reference images are taken, and are inputted into the image memory 18-2. An axis of abscissas t denotes a time. Reference numerals 50-1 to 50-4 denote the processing time of the defect detection unit 18-3 performed to each image unit. In this manner, in the ordinary parallel processing, at the same time when the images are inputted, the images are transferred in sequence to the slave CPUs from the master CPU, and the slave CPUs perform the same processing in parallel. The slave CPUs are inputted with the next image after completion of a series of the processing.

FIG. 5B shows a flow of a pipeline processing for the same image, which shows the position shift detection processing to the position adjustment processing (303) shown in the defect detection processing in FIG. 3 by an oblique hatching; the feature amount calculation to the feature space forming processing (304 and 305) by a black color; and the shifted pixel detection processing (306) of the defect candidate by a white color by corresponding to the processing time. An exclusive slave CPU is allotted to each processing, and each slave CPU repeatedly performs the allotted processing. In this example, since data is transmitted in sequence after going though the processings of the upper slave CPUs, the data is not transferred unless the upper processing is terminated.

For example, when the position adjustment processing (303) (the oblique hatching portion performed by the slave CPU 410) takes twice time than other processings, as shown in FIG. 5C, the subsequent processings 304 to 306 (processings of the slave CPUs 420 and 430) increase the waiting time for the process completion of the slave CPU 410 (shown by the broken line in the figure), thereby deteriorating the processing speed as a whole. For example, the extraction of a defect candidate of the image 43 takes a time t2 which has elapsed after the image 43 was inputted. To prevent such a delay from occurring, in the present system configuration, according to the calculation time of each processing, the number of slave CPUs in charge can be freely changed, so that the calculation waiting time of the CPU is not made to be generated as much as possible.

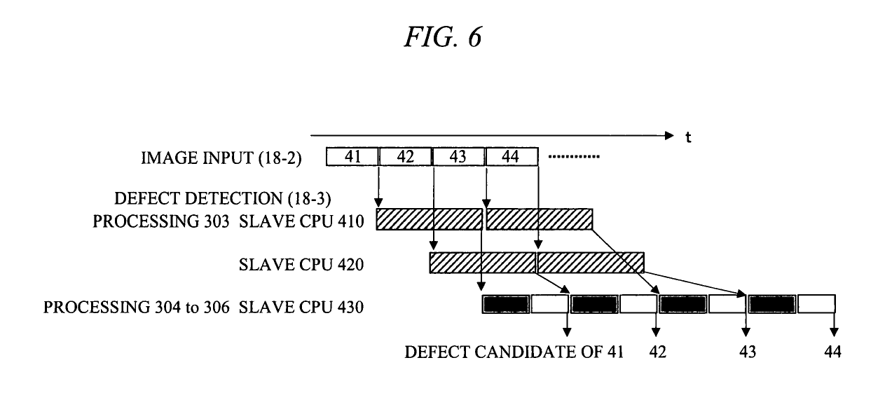

FIG. 6 is an example of reducing the calculation waiting time with respect to FIG. 5C. According to this example, since the calculation load of the position adjustment processing (303) shown by the oblique hatching is about two times that of other processings, the position adjustment processing (303) is performed by two slave CPUS 410 and 420. At this time, to prevent the waiting time for calculation from occurring, the processings of the images 41 to 44 continuously inputted are alternately performed by the slave CPU 410 and 420. Further, the feature amount calculation processing to the defect candidate extraction processing (304 to 306), which have a small calculation load, are performed by one slave CPU 430. This makes it possible to speed up the processing by the same number of CPUs as FIG. 5C.

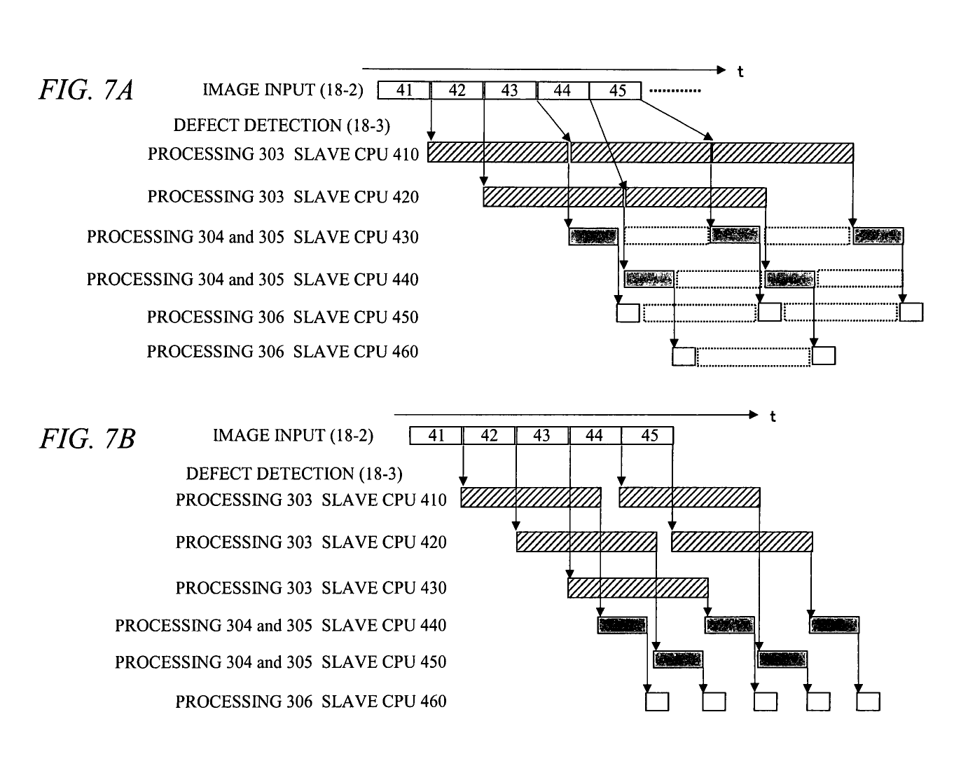

FIG. 7 is another example of the effect obtained by the present system configuration. FIG. 7A is an example of performing pipeline processings by six slave CPUs 410 to 460 for the images 41 to 45 continuously inputted. According to this example, the processings 303 to 306 are processed in parallel by the two slave CPUs. Further, the calculation load of each processing includes a considerable variation. By doing this, the calculation waiting time of the CPUs (slave CPUs 450 and 460) which have a light calculation load shown by the broken line in the figure is made longer. In such case, in the present system configuration, as shown in FIG. 7B, the processing 303 which has the heaviest calculation load is performed by three slave CPUs 410, 420, and 430; the processings 304 and 305 are performed by two slave CPUs 440 and 450; and the processing 306 which has the lightest calculation load is performed by the slave CPU 460. In this manner, by the efficient use of the CPUs, the speeding up can be realized. When the calculation load of each processing of the defect detection unit 18-3 is arbitrarily changed by the change of the processing content and the like, equalization of the load becomes easily possible in the present system configuration.

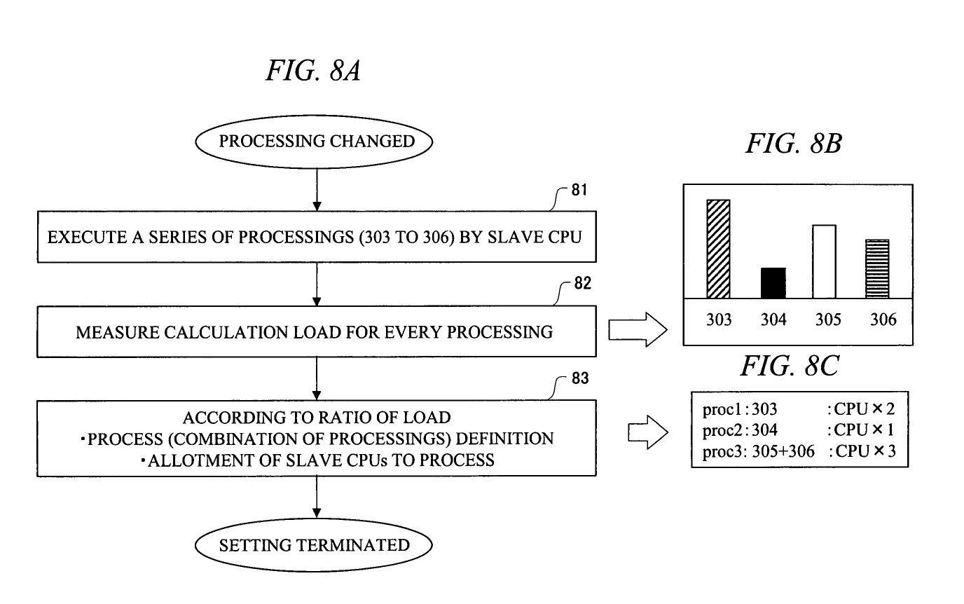

FIG. 8A is a flow of the load equalization processing. First, when a part (for example, either one of 303 to 306) of the content of the defect detection processing is changed, the individual detailed processing is executed by the slave CPU (81), and as shown in FIG. 8B, the calculation load ratio of each processing is measured (82). According to the load ratio of each processing, the process allotted to one slave CPU is defined, and the number of slave CPUs executing the defined process is allotted (83). This is decided by considering such that the calculation waiting time of the slave CPU should be finally made shorter. FIG. 8C is such an example. Here, it is shown that three processes of the processings 303, 304, and 305 to 306 are defined and the salve CPUs for calculation are respectively allotted two, one, and there CPUs for each processing. By doing this, setting of allotment of the CPUs according to the change of the processing content is completed. The master CPU performing the control of the processing transfers a set of an algorism showing the individual processing content and an image to the slave CPUs, whereby the defect detection processing which is set is executed.

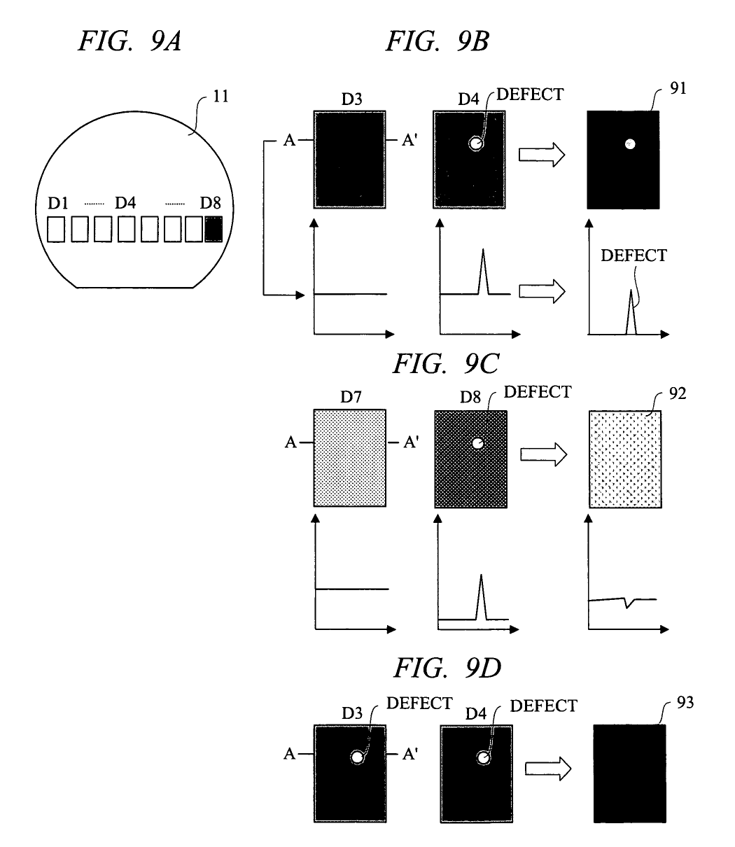

An example of executing the defect detection processing shown in FIG. 3 at high speed has been shown as above. However in reality, there are often the cases where the defect inspection by the comparison of the chips is difficult. Such an example will be shown in FIG. 9. FIG. 9A is an example of the semiconductor wafer of the sample 11. Eight chips D1 to D8 are disposed. FIG. 9B is an example of detecting the defect of the chip D4 by the comparison of the images of the chip D3 and D4. There is a defect in the chip D4. Reference numeral 91 denotes a differential image showing the absolute value d of the difference of the brightness between the corresponding pixels of the chips D3 and D4.

The Absolute Difference Value:

d(x, y)=|D4(x, y)−D3(x, y)|

When the pixel has lager difference value, the pixel is displayed brighter. Waveforms represent a brightness signal on the line A-A′ of each image. When the brightness between the chips is almost the same like D3 and D4, a portion where the difference of the brightness is large can be easily detected as a defect. FIG. 9C is an example where a defect of the chip D8 is detected by the comparison of the images between the chips D7 and D8 located at the edge. At the edge of the semiconductor wafer such as the chip D8, due to the thickness variation, the difference of the brightness tends to become large with respect to the adjacent chip. In the example of FIG. 9C, as shown by the waveforms, the chip D8 is darker in non-defect portion than the chip D7. On the other hand, the chip D8 is brighter in defect portion. In this case, the absolute difference value d of the brightness is almost the same between the defect portion and the non-defect portion, and therefore, it is difficult to detect the defect. FIG. 9D shows an example where the defects are located at the same positions of the chips D3 and D4. When there is a defect in a mask which forms a pattern of the chip, the defect is likely to occur in the same position of the chip as described. In the example of FIG. 9D, the absolute difference value d of the brightness between the defect portions becomes small, and therefore, it is difficult to detect the defect.

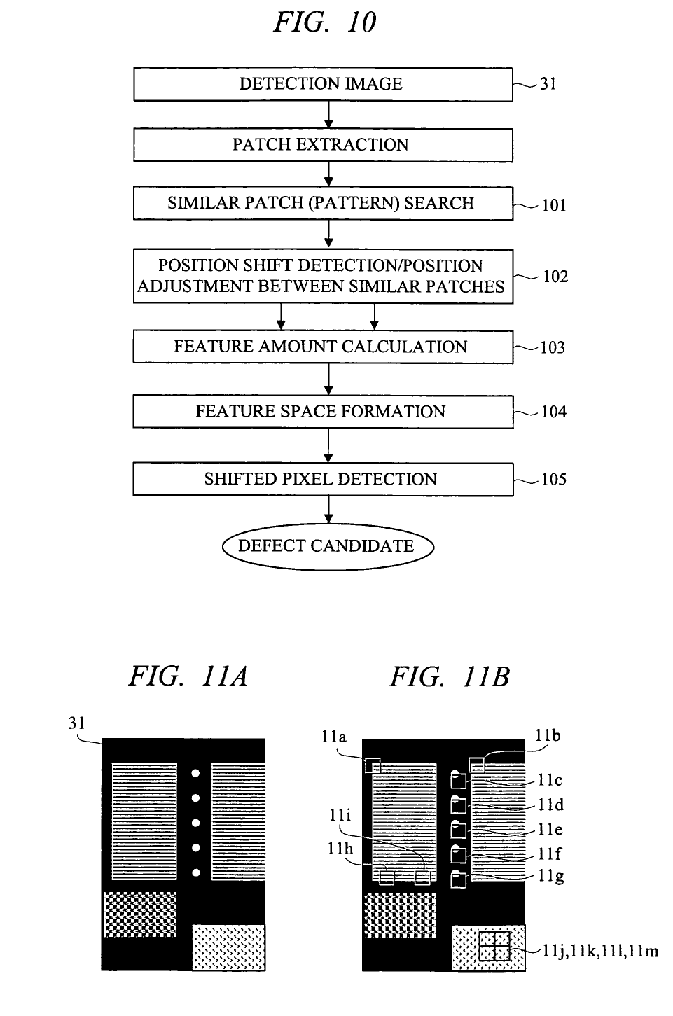

Thus, when brightness variation between the chips is large or when the defects occur in the same positions of the chips and the like, the present invention makes it possible to detect a defect from a single image with respect to defects not detectable by the comparison between the chips. FIG. 10 shows an example of a processing where the defect is detected from the single chip image. In this example, the processing content is almost the same as FIG. 3. First, the image (detection image 31) of the chip being the inspection target is read from the image memory 18-2. Next, the inputted image is separated into small areas. With respect to each small area, a small area containing a pattern similar to the pattern contained in the area is searched (101). Hereinafter, the small area is described as a patch. Concerning the search as to whether the similar pattern is contained or not, distribution of the feature inside the patch, for example, the above described (1) Brightness, (2) Contrast, (4) Brightness Dispersion Value of the Adjacent Pixel, (5) Coefficient of Correlation, (6) Increase and Decrease of Brightness with the Adjacent Pixel, and (7) Second Derivative Value, and in addition, a direction component showing texture information are measured for each pixel, and a distribution shape difference of the feature amount inside the patch is examined for the search.

Here, even when the patch containing the similar pattern is found, there is a high possibility that a difference of the position cut out as the patch occurs with respect to the pattern. Hence, a position difference is detected between the patches, and a position adjustment is performed (102). Next, a plurality of feature amounts are calculated for each pixel of the patch image subjected to the position adjustment (103). The feature amount here may be the same as the case where the chips are compared. By plotting each pixel in a space where some or all the feature amounts from among these feature amounts are taken as an axis, a feature space is formed (104). Then, the pixel plotted outside the data distribution in this feature space, that is, the pixel having a characteristic shifted value is detected as a defect candidate (105). The defect detection processing is not limited to the present embodiment, but may be any processing capable of detecting the defect from the single chip.

FIG. 11A is an inspection image 31 to be an inspection target. FIG. 11B is an example of a similar patch in the detection image 31. The patches 11a and lib are the similar patches, and are subjected to the detection inspection by comparison. Similarly, patches 11c, 11d, 11e, 11f and 11g are the similar patches, and patches 11j, 11k, 11l, and 11m are the similar patches, and patches 11h and 11i are the similar patches, and are respectively subjected to the detection inspection by comparison.

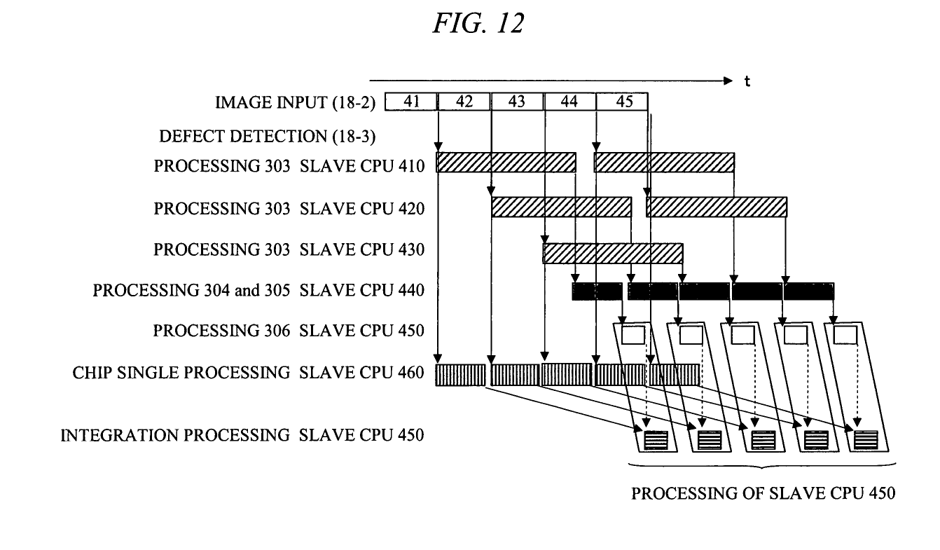

In the defect inspection apparatus according to the present embodiment, the defect detection processing from the single chip may be independently performed or may be performed simultaneously with the defect detection processing by the comparison of the chips. Further, only for a specific chip such as a chip on the end of the wafer, the defect detection processing from the single chip may be replaced by the defect detection processing by the comparison of the chips or both inspection processings may be performed simultaneously. FIG. 12 shows a processing flow where the processing by the comparison of the chips as described in FIG. 3 and the processing with the single chip are executed by the present image processing system.

FIG. 12 is an example where the processing shown in FIG. 7B and the defect detection processing (shown by vertical strips in the figure) with the single chip are simultaneously performed. In the present system configuration, the processing 303 which is the heaviest calculation load is performed by three slave CPUs 410, 420, and 430, and the processings 304 and 305 are performed by one CPU 440. Further, the processing 306 which is the lightest calculation load is performed by the slave CPU 450. Still further, the processing with the single chip is performed by one slave CPU 460. In this processing, the image memory is inputted with an image, and the master CPU transfers the image to the slave CPUs 410, 420, and 430 which perform the processing 303 at the same time, and also transfers the image to the salve CPU 460 which performs a single chip processing at the same time. As a result, the processing of the defect detection unit 18-3 and the single chip processing can be performed in parallel. Further, finally there is a necessity of integrating the defect detected by the processing of the defect detection unit 18-3 and the defect detected from the single chip processing to output them as defect information, and this integrating processing is executed by the slave CPU 450 having much calculation wait time. This is performed by returning the result of the single chip processing by the slave CPU 460 to the slave CPU 450. Thus, in consideration of the equalization of the load, by efficient allotment of CPUs, no large delay in time is caused, and moreover, addition of different algorisms and the parallel processing can be realized without increasing the scale of the system.

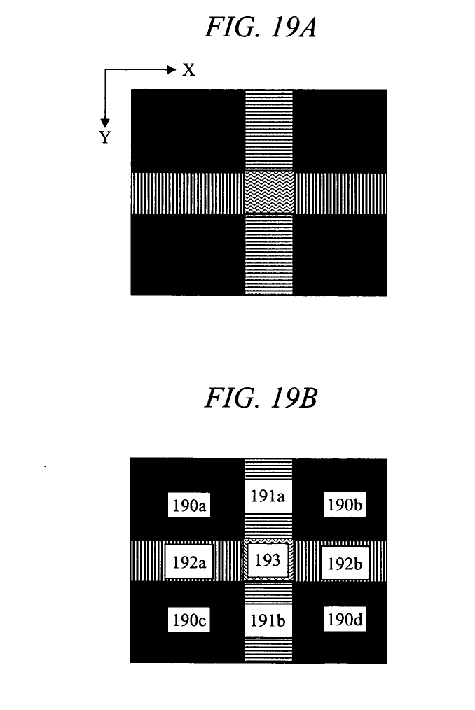

Next, an example of processing plural different algorisms in parallel will be shown in FIG. 19. FIG. 19A shows an image to be inputted. This image is divided into four large areas which are a horizontal stripe pattern area, a vertical strip pattern area, no pattern area, and a random pattern area according to the pattern shape. In such case, the parallel processing is performed by four different comparison methods. First, in the horizontal pattern areas (191a and 191b of FIG. 19B), since the similar patterns are repeatedly arranged in the Y direction of the image, brightness comparison is performed between the pixels shifted in Y direction by a pattern pitch. Further, in the vertical pattern areas (192a, and 192b of FIG. 19B), since the similar patterns are repeatedly arranged in the X direction of the image, the brightness comparison is performed between the pixels shifted in the X direction by a pattern pitch. Further, in the area having no pattern (190a, 190b, 190c, and 190d of FIG. 19B), a comparison with the threshold value is simply performed. Further, in the center random pattern area (193 of FIG. 19B), a comparison between the adjacent chips is performed. At this time, the master CPU allots four processings to the slave CPUs, respectively, and transfers a rectangular image which is cut out according to the pattern shape and an algorism for executing the processing to each slave CPU allotted with the processing, so that the four different processings can be easily performed in parallel.

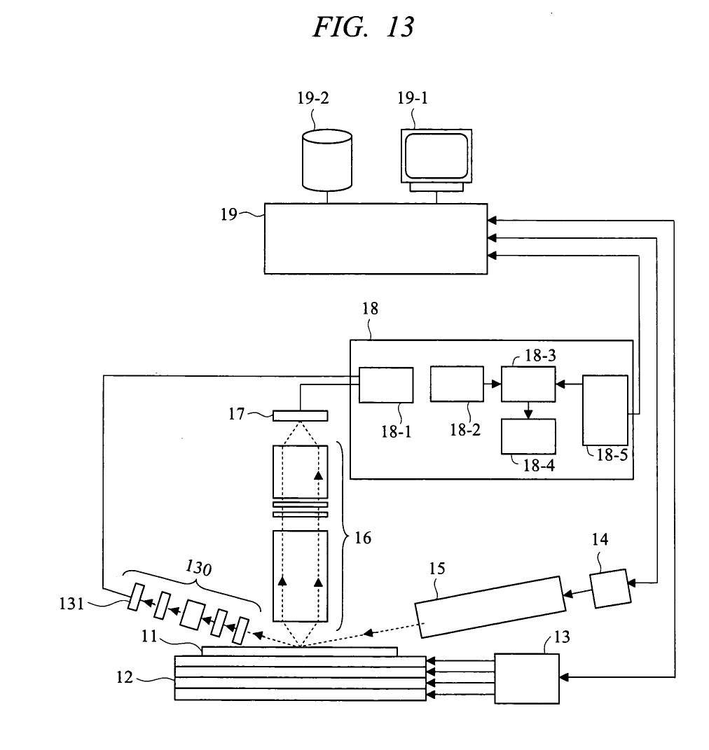

Next, another example of the present pattern inspection method having an image processing system of the above described system configuration will be described with the case of having a plurality of detection optical systems for detecting an image. FIG. 13 is an example where two detection optical systems are provided in the defect inspection apparatus with the dark-field illumination shown in FIG. 1. Reference numeral 130 in FIG. 13 denotes an oblique detection system, and as with the upper detection system 16, scattered light from the sample 11 is formed into an image, and an optical image is received by an image sensor 131 to convert it into an image signal. The obtained image signal is inputted to the image comparison processing unit 18 which is also for the upper detection system, and is processed. Here, it goes without saying that the images taken by two different detection systems are different in image quality, and kinds of defects to be detected are also partly different. Hence, by integrating the information on each detection system and detecting the defect, it is possible to detect a variety of kinds of defects.

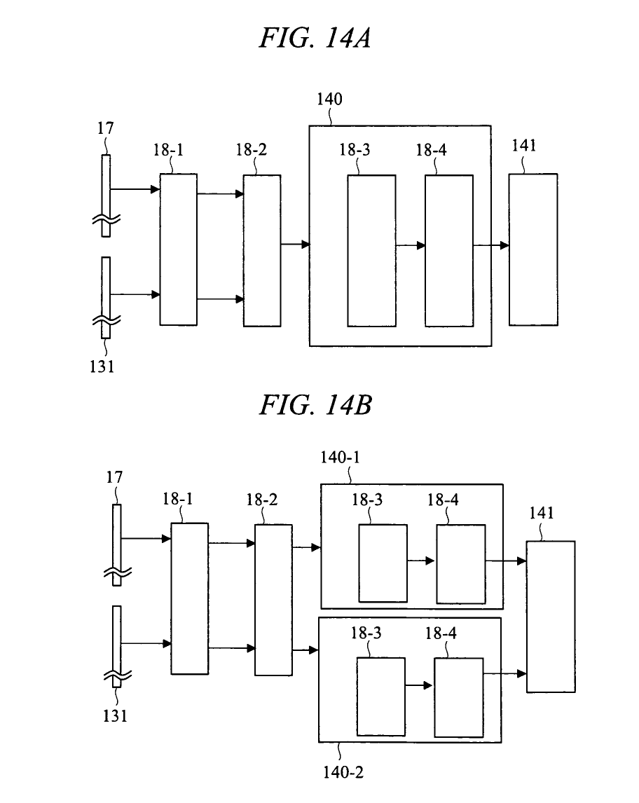

As an example of the integration of the information by a plurality of detection systems, with respect to each image signal of every detection system corrected by the pre-processing unit 18-1 and inputted into the image memory 18-2, as shown in FIG. 14A, the extraction processing to the classification processing of the defect candidate are sequentially performed by a defect detection/classification unit 140 of FIG. 14, and the final result can be individually displayed for every detection system. Also, with respect to the defect extracted from each detection system, the defect is collated from the coordinates inside the semiconductor wafer in the defect information integration processing unit (141 of FIG. 14), and the logical product (the defect commonly extracted by different detecting systems) and the logical sum (the defect commonly extracted by different detection systems or extracted by either one of the systems) are taken, whereby the result can be integrated and displayed. Further, with respect to each image signal of every detection system, as shown in FIG. 14B, the extraction processing to the classification processing of the defect candidate are performed in parallel by the defect detection and classification units 140-1 and 140-2 of FIG. 14, and the final result can be also integrated and displayed by the defect information integration processing unit 141.

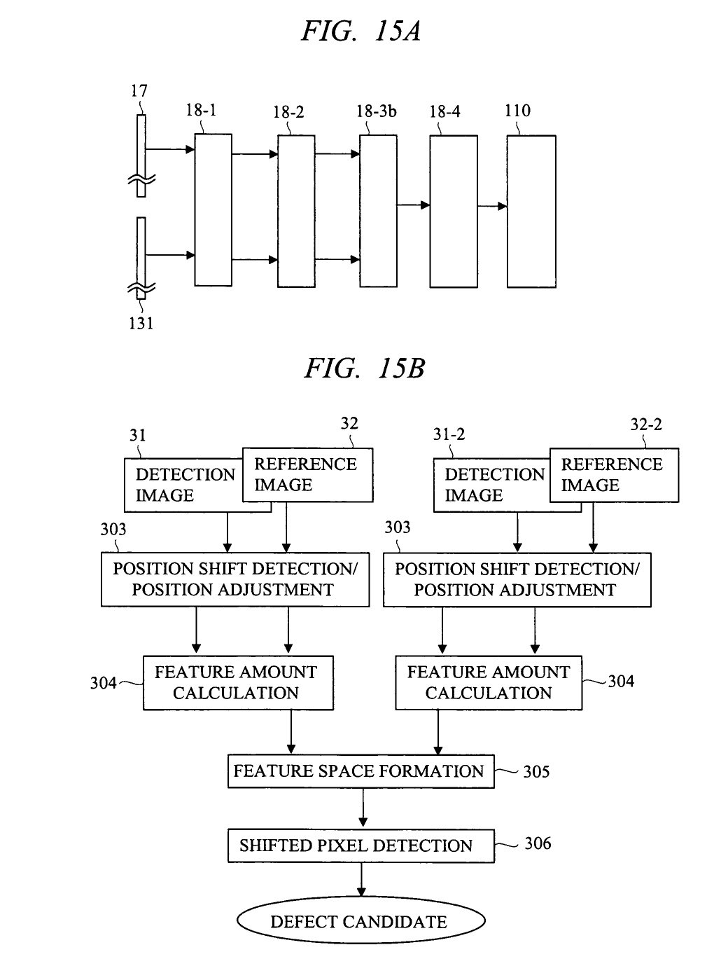

Further, rather than the result extracted by a plurality of detection optical systems is simply integrated and displayed, the information from each detection system can be also integrated so as to perform the defect detection processing. The case where an imaging magnification power of each detection optical system is the same will be described. FIG. 15A shows an example in which the images of the two detection optical systems are simultaneously obtained with the same magnification power. Each image obtained at the same timing by the two image sensors 17 and 131 is corrected by the pre-processing unit 18-1, and is inputted to the image memory 18-2. By using a set of the inspection target images taken by the two different detection systems and the reference image, the defect candidate is extracted by the defect detection unit 18-3b. Then, after classifying them by the defect classification unit 18-4, the result thereof is displayed in the display unit 110.

FIG. 15B is an example of the processing flow of the defect detection unit 18-3b. First, a detection image 31 obtained from one detection system (here, upper detection system) and a corresponding reference image 32 are read from the image memory 18-2. Then, a shift of the position is detected, and the position adjustment is performed (303). Next, with respect to each pixel of the detection image 31 subjected to the position adjustment, the feature amount is calculated between the pixel and the corresponding pixel of the reference image 32 (304). Similarly, a detection image 31-2 obtained from another detection system (here, an oblique detection system) and a reference image 32-2 are also read from the image memory 18-2. Then, the position adjustment and the feature amount calculation are performed. Then all or some of these feature amounts are selected to form a feature space (305). As a result, the information on the images obtained from the different detection systems is integrated. The value shifted from the formed feature space is detected to extract a defect candidate (306).

Concerning the feature amount, the above described (1) Brightness, (2) Contrast, (3) Contrast Difference, (4) Brightness Dispersion Value of the Adjacent Pixel, (5) Coefficient of Correlation, (6) Increase and Decrease of Brightness with the Adjacent Pixel, and (7) Second Derivative Value, and the like are calculated from each set of the images. In addition, the brightness itself of each image (31, 32, 31-2, and 32-2) is also taken as the feature amount. Further, the images of each detection system are integrated, and for example, the feature amounts of (1) to (7) may be determined from the average values of 31 and 31-2, and 32 and 32-2. Here, to integrate the information on the feature space, the pattern positions must have the correspondence between the images of different detection systems. The correspondence of the positions may be calibrated in advance or calculated from the obtained image.

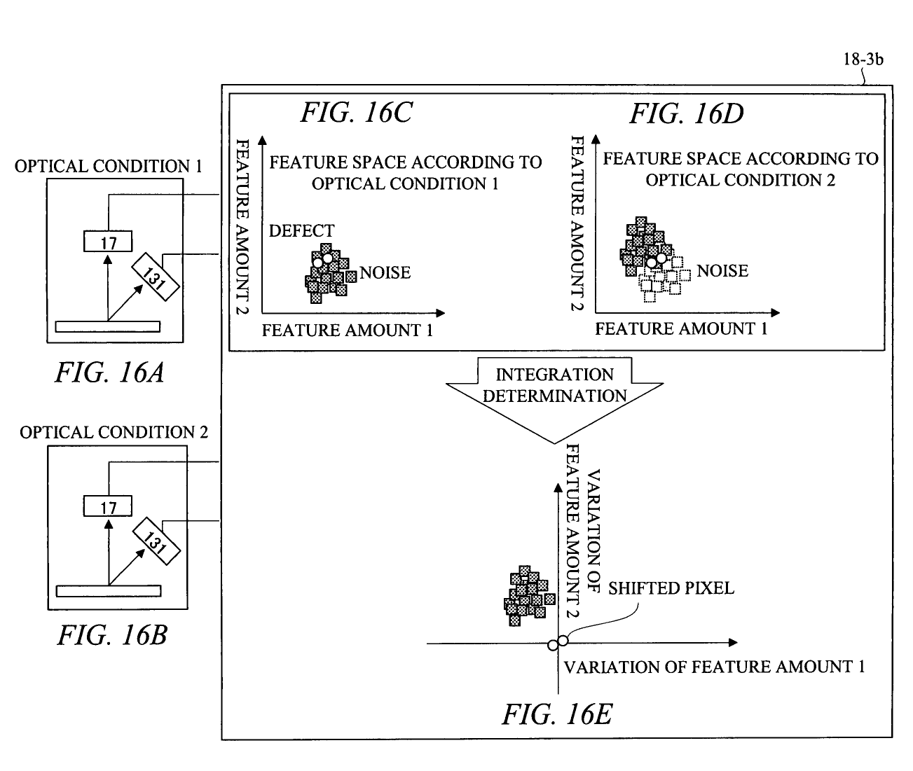

Hereinbefore, the integration of the images of the same area under the two different detection conditions has been described. However, the integration of the images from a plurality of two or more detection systems is also possible. Further, a difference of condition is not limited to the detection conditions alone, but the images of the same area can be integrated and processed under different illumination conditions. In FIG. 16, an example of its processing is shown. FIG. 16A shows acquisition of an image under a certain optical condition (here, optical condition 1). FIG. 16B shows acquisition of the image of the same area under an optical condition different from the optical condition 1 in FIG. 16A (here, optical condition 2). Then, in the defect detection unit 18-3b, the information on these images is integrated to perform the defect processing. In the present embodiment, two feature amounts are calculated from the image obtained under the optical condition 1 to form a feature space shown in FIG. 16C. On the other hand, the same feature amounts are also calculated from the images obtained from the optical condition 2 to form a feature space shown in FIG. 16D. Each pixel is plotted on a feature space with axes of the variation of the common feature amounts calculated from these images different in appearance, which is shown in FIG. 16E, and the shifted value in this variation vector space is extracted as a defect. This processing is performed every detection system. As a result, the defect is separated from noise (normal pattern), and a variety of defect detections can be realized with high sensitivity.

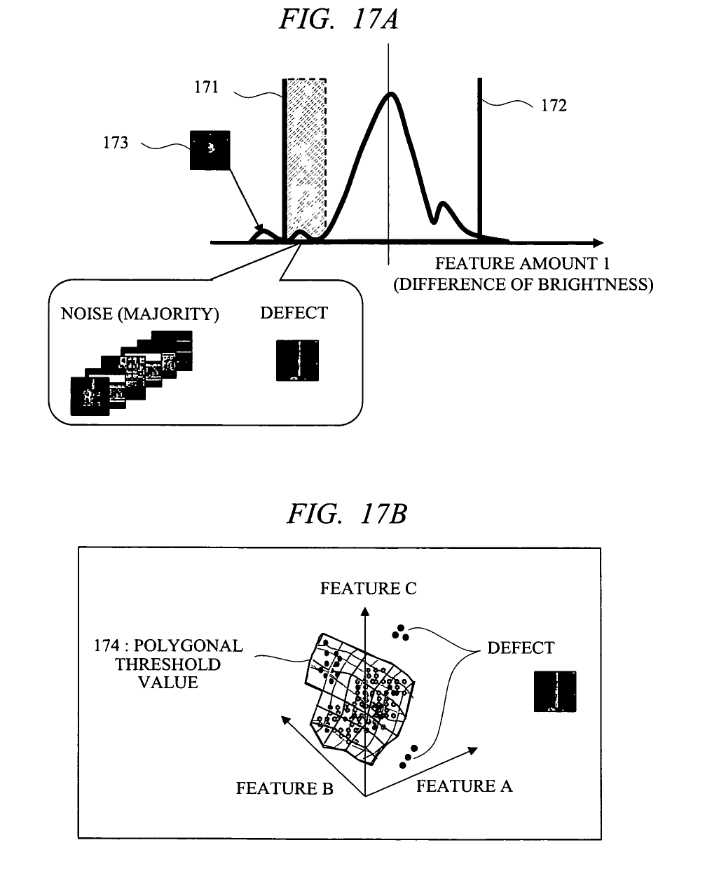

Here, it is difficult for the user to set the threshold value for detection of the shifted value of FIG. 16E. Therefore, in the present inspection apparatus, the threshold value in the feature space is automatically set up. FIG. 17A is a one dimensional feature space characterized in the difference of the brightness. Conventionally, in this one dimensional feature space, an apparently normal range is set as the threshold value by the user (171 and 172 in the figure), and a feature amount value existing outside the range is detected as the defect (173 in the figure). There is a possibility that the area shown by the meshing inside the threshold values contains the defect. However, just by a difference of the brightness, it is difficult to distinguish the defect from the noise, and moreover, because most of the feature amount values are often the noise, if the noise is made not to be detected, the defects existing there are not detected. However, as described above, the defect and the noise are separated by increasing the feature amounts, and the threshold values are set, so that only the defect can be extracted. FIG. 17B is a three dimensional feature space into which the one dimensional feature space shown in FIG. 17A is converted. If the defect and the noise existing in the meshing area of FIG. 17A are separated and a polygonal threshold value as shown by the reference numeral 174 in the figure can be set, the defect can be detected. However, it is difficult for the user to set the polygonal threshold value such as 174 in the multi-dimensional feature space.

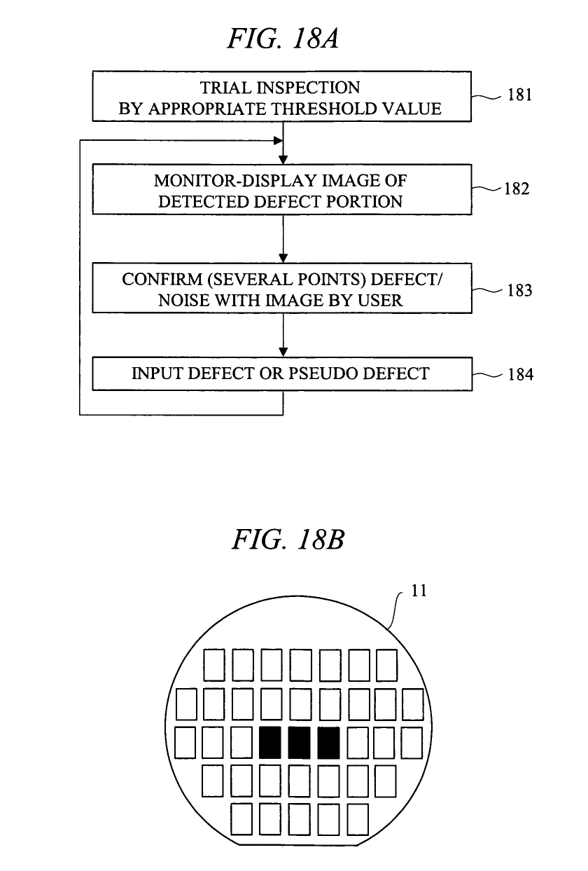

Hence, in the present invention, the user inputs determination of whether detection of the defects is performed or not on the image, so that setting of the threshold value is made to be unnecessary. FIG. 18A is an example of the setting procedure of the polygonal threshold value 174. First, an appropriate parameter (usually, a defect determination threshold value for the difference of the brightness between the chips) is set to perform a trial inspection (181). As shown by a black color of FIG. 18B, the trial inspection is an inspection in which the inspection target chips are limited and the inspection is performed in a short time. The parameter is automatically adjusted based on this result. First, the defect image, which cuts a peripheral portion including the defect candidate detected by the trial inspection, and the image (reference image) of the corresponding adjacent chip are displayed in the monitor (182). The user confirms whether it is the defect or the noise from the displayed image (183), and the user inputs the determination result obtained from the image (184). This is performed for several points of the defect candidates. This operation is performed until the noise is suppressed to some extent. In the present system, based on the inputted information from the user, the polygonal threshold value is calculated on the feature space between the noise and the defect to renew the parameter. Thus, the user just looks at the image and inputs either the defect or the noise, so that a sensitivity parameter capable of separating the defect and the noise can be set up without performing setting of the complicated parameters.

As described above, according to the inspection apparatus as described in each of the embodiment of the present invention, the system configuration of the image comparison processing unit is configured with the master CPU, the plurality of slave CPUs, and a mutually inverse data transfer bus. Accordingly the defect detection method in which each processing is freely allotted to the CPU and the processing is performed with high speed, and the defect detection apparatus using the method can be provided. Further, by detecting the shifted value in the feature space, the defect buried in the noise can be detected with high sensitivity. Further, when the user confirms the image of the defect candidate detected by the trial inspection and inputs whether it is a defect or a noise, the polygonal threshold value for distinguishing the defect from the noise based on that information is calculated, so that the user can perform a sensitivity setting with high sensitivity without performing a parameter setting at all. Further, with respect to a plurality of images of the same area detected by a plurality of detection optical systems or by a plurality of illumination conditions, the information thereof is integrated and the defect detection processing is performed, whereby a variety of defects can be detected with high sensitivity.

In the present embodiment, an example in which a comparison inspection is performed with the image (22 of FIG. 2) of the adjacent chip as the reference image has been shown. However, one reference image may be generated from the average value of the plurality of chips (21, 22, 24, and 25 of FIG. 2) and the like. And a comparison of one for one such as 23 and 21, 23 and 22, . . . , 23 and 25 is performed in the plural areas, and all the comparison results are statistically processed to detect the defect, which also falls within the range of the invention of the present method.

Until now, a description of the invention has been made with the comparison processing of the chips as an example. However, when the peripheral circuit unit and the memory matt unit coexist in the target chip to be inspected as shown in FIG. 2B, the cell comparison performed in the memory matt unit also falls with the range of the present invention.

Further, even when there are a fine difference of the pattern thickness after a planarizing processing such as CMP and a large difference of brightness between the chips to be compared due to shorter wavelength of an illumination light, the present invention makes it possible to detect the defect of 20 nm to 90 nm.

Further, in the inspection of a low k film such as an inorganic insulating film, for example, SiO₂, SIOF, BSG, SiOB, and a porous silia film, and such as an organic insulating film, for example, a SiO₂ containing methyl group, MSQ, a polyimide based film, a parylene based film, and a Teflon (registered trade mark) based film, even when there is a difference of local brightness due to the inter-film fluctuation of refractive index distribution, the present invention makes it possible to detect the defect of 20 nm to 90 nm.

As described above, one embodiment of the present invention has been described with the comparison inspection image in the dark-field inspection apparatus for the semiconductor wafer as an example. However, the invention is also applicable to comparison images in an electron beam pattern inspection. Further, the invention is also applicable to pattern inspection apparatus of bright field illumination.

The inspection target is not limited to only the semiconductor wafer, and therefore, those, for example, a TFT substrate, a photo mask, and a printed board, can be applicable as long as detection of the defect is performed by comparison of the images.

The effects obtained by typical aspects of the present invention will be briefly described below.

According to the present invention, the feature amount suitable for detecting the defect buried in the noise is automatically selected from the plurality of feature amounts, so that the defect can be detected from among the noises with high sensitivity.

Further, the high sensitivity inspection can be realized without setting the parameters.

Further, the information obtained from the plural optical systems is integrated at each processing stage, so that a variety of kinds of defects can be detected with high sensitivity.

Further, a systematic defect occurring at the same position of each chip can be detected, and at the same time, the defect located at the end of the wafer can be also detected.

Further, these high sensitive inspections can be performed at high speed.

As described above, the pattern inspection method and the pattern inspection apparatus of the present invention relate to an inspection in which the image of an target obtained by using light, laser, or electron beam is compared with the reference image to detect a micro pattern defect, a foreign matter and the like based on the comparison result. In particular, the pattern inspection method and the pattern inspection apparatus are suitably applicable for performing an appearance inspection of a semiconductor wafer, TFT, a photo mask, and the like.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A pattern inspection method for taking a plurality of images of areas corresponding to patterns each formed to be the same pattern on a sample and comparing the images to detect a defect, the method comprising the steps of:
imaging a pattern on the sample being an inspection target to continuously obtain an image of an inspection target pattern and an image of a corresponding reference pattern;
calculating a plurality of feature amounts for each pixel of the obtained inspection target image and a reference image by using a processing system mounting a plurality of CPUs operating in parallel; and
comparing the feature amounts of each pixel corresponding to the inspection target image and the reference image to detect a defect.

2. The pattern inspection method according to claim 1,
wherein the processing system performs a defect detection processing in time sequence or in parallel for a plurality of inspection target images continuously obtained and sequentially inputted.

3. The pattern inspection method according to claim 1,
wherein detection of a defect by comparison of the image of the inspection target pattern and the image of the corresponding reference pattern comprises the steps of:
performing position correction for matching a coordinate inside the image of the inspection target pattern with a coordinate inside the image of the corresponding reference pattern;
calculating a plurality of feature amounts from the image of the inspection target pattern subjected to the position correction, and each corresponding pixel of the image of the reference pattern;
extracting a pixel shifted from distribution of a normal range as a defect candidate in a feature space with a plurality of the calculated feature amounts as an axis; and
classifying the extracted defect candidate into plural kinds of defects.

4. The pattern inspection method according to claim 3,
wherein setting of the normal range in the feature space is performed by a user specifying a defect and a normal pattern from an image.

5. The pattern inspection method according to claim 3,
wherein a threshold value for extracting the pixel shifted from the distribution of the normal range is automatically calculated in the feature space.

6. The pattern inspection method according to claim 1,
a threshold value set by a user for performing a defect determination is not present.

7. The pattern inspection method according to claim 1,
wherein when a user specifies an image of a non-defect portion, a plurality of feature amounts are calculated for a pixel of the specified non-defect portion,
a defect determination threshold value is calculated based on distribution of the a non-defect portion on a feature space with the calculated feature amounts as an axis, and
a pixel at a distance from the defect determination threshold value is detected as a defect for the calculated distribution of the non-defect portion.

8. The pattern inspection method according to claim 7,
wherein one or plural features are selected from the plurality of feature amounts, and
a defect determination is performed on a feature space with the selected features as an axis.

9. A pattern inspection method for taking a plurality of images of areas corresponding to pattern each formed to be the same pattern on a sample and comparing the images to detect a defect, the method comprising the steps of:
imaging a pattern being an inspection target on a sample by a plurality of detection systems,
obtaining a plurality of images of an inspection pattern and a plurality of images of a corresponding reference pattern from different detection systems;
calculating a plurality of feature amounts for each pixel of an inspection target image and a reference image obtained from each detection system; and
detecting a defect in a feature space with the plurality of feature amounts calculated from the images of different detection systems, the plurality of feature amounts being as an axis.

10. The pattern inspection method according to claim 9,
wherein the feature amount to be compared for performing an defect determination is calculated from an image of a corresponding place obtained by different illumination conditions.

11. A pattern inspection method for taking a plurality of images of areas corresponding to patterns each formed to be the same pattern on a sample and comparing the images to detect a defect, the method comprising the steps of:
imaging a pattern on a sample being an inspection target under a plurality of illumination conditions to obtain a plurality of images of an inspection pattern and a plurality of images of a corresponding reference pattern from different illumination conditions;
calculating a feature amount from each corresponding pixel of the image of the inspection target pattern and the image of the reference pattern obtained by each illumination condition; and
detecting a defect in a feature space with the plurality of feature amounts calculated from the images different in illumination condition, the plurality of feature amounts being defined as an axis.

12. A pattern inspection method for taking a plurality of images of areas corresponding to patterns each formed to be the same pattern on a sample and comparing the images to detect a defect, the method comprising the steps of:
imaging a pattern on a sample being an inspection target to obtain an image of an inspection target pattern and an image of a corresponding reference pattern;
dividing the image into a plurality of areas by using a processing system mounting a plurality of CPUs operating in parallel, for each pixel of the obtained inspection target image and reference image; and
detecting a defect by performing different detect determination processings in parallel for every divided area by using the processing system.
